(19) United States
(12) Patent Application Publication
(10) Pub. No.: US 2006/0046122 A1
(43) Pub. Date: Mar. 2, 2006

(54) Composite electrolyte membrane

(76) Inventors: Hyuk Chang, Seongnam-si (KR); Hasuck Kim, Seoul (KR); Hae-kyoung Kim, Seoul (KR); Sang-ook Park, Seoul (KR); Jin-kyu Lee, Seoul (KR); Shin-woo Ha, Seoul (KR)

Correspondence Address: McGuireWoods LLP;Suite 1800, 1750 Tysons Boulevard, McLean, VA, 22102, US

(21) Appl. No.: 11/188,659

(22) Filed: Jul. 26, 2005

(30) Foreign Application Priority Data
Aug. 30, 2004 (KR) 10-2004-0068600

(51) Int. Cl. H01M 8/10; B05D 5/12

(52) U.S. Cl. 429/33; 427/115

(57) ABSTRACT

A new composite electrolyte membrane that has excellent hydrogen ion conductivity, and excellent methanol exclusion, a manufacturing method for such a composite electrolyte membrane, and a fuel cell using such a composite electrolyte membrane are provided. The composite electrolyte membrane comprises a hydrogen ion conductive polymer membrane and an exfoliate layer comprising layered hydrogen ion conductive inorganic materials that are disposed on a surface of the polymer membrane.

### CROSS-REFERENCE TO RELATED APPLICATION

This application claims priority to and the benefit of Korean Patent Application No. 10-2004-0068600, filed on Aug. 30, 2004, in the Korean Intellectual Property Office, the disclosure of which is incorporated herein in its entirety by reference.

### BACKGROUND OF THE INVENTION

1. Field of the Invention

The present invention relates to an electrolyte membrane, and more particularly, to a composite electrolyte membrane that comprises organic and inorganic materials.

2. Description of the Related Art

An electrolyte membrane may be used as a medium that can transfer ions in various electrochemical devices such as fuel cells. Examples of a fuel cell that use an electrolyte membrane comprising a polymer or a polymer/inorganic composite material are a proton exchange membrane fuel cell (PEMFC) and a direct methanol fuel cell (DMFC).

In particular, the DMFC that uses a methanol solution as a fuel is operable at room temperature and can easily be miniaturized. Thus DMFCs are widely used as power sources in pollution-free automobiles, home-use power generation systems, mobile communications equipment, medical devices, military equipment, aerospace equipment, and portable electronic devices, for example.

A basic structure of the DMFC is shown in FIG. 1. Referring to FIG. 1, the DMFC includes an anode 120 to which fuel is supplied, a cathode 130 to which oxidizers are supplied, and an electrolyte membrane 110 that is interposed between the anode 120 and the cathode 130. Generally, the anode 120 consists of an anode diffusion layer 122 and an anode catalyst layer 121, and the cathode 130 consists of a cathode diffusion layer 132 and a cathode catalyst layer 131. A separation plate 140 comprises a channel for supplying fuel to the anode and acts as an electron conductor that passes electrons that are generated at the anode to an outer circuit or an adjacent unit cell. A separation plate 150 comprises a channel for supplying oxidants to the cathode and acts as an electron conductor that passes electrons that are supplied from an outer circuit or an adjacent unit cell to the cathode. A methanol solution is commonly used as a fuel that is supplied to the anode of the DMFC and air is commonly used as an oxidant that is supplied to the cathode.

The methanol solution that is supplied to the anode catalyst layer 121 through the anode diffusion layer 122 is decomposed into an electron, a hydrogen ion, carbon dioxide, and so on. The hydrogen ion is transferred to the cathode catalyst layer 131 through the electrolyte membrane 110, the electron is transferred to the outer circuit, and the carbon dioxide is exhausted to the outside environment. At the cathode catalyst layer 131, the hydrogen ion electrons that are transferred from the outer circuit and the oxygen in the air that is supplied through the cathode diffusion layer 132 all react to form water.

In this type of DMFC, the electrolyte membrane 110 functions as a hydrogen ion conductor, an electron insulator, and an isolation membrane. In this case, an isolation membrane restrains unreacted fuels from moving to the cathode and unreacted oxidants from moving to the anode.

A cation exchanging polymer electrolyte such as a perfluorinated sulfonic acid polymer (Ex: Nafion® DuPont) which comprises a fluorinated alkylene as a backbone and fluorinated vinyl ether that has a sulfonic acid group at its terminal may comprise an electrolyte membrane. Such a polymer electrolyte membrane may have sufficient ion conductivity by proper hydrating.

However, water and methanol may penetrate into the polymer electrolyte membrane of a DMFC. As described above, a methanol solution is supplied to the anode and the unreacted methanol may partially penetrate the polymer electrolyte membrane. The methanol in the polymer electrolyte membrane may cause swelling of the electrolyte membrane or it may diffuse into the cathode catalyst layer. The phenomenon in which methanol that is supplied to the anode is transferred to the cathode through the electrolyte membrane is referred to as “methanol crossover.” Methanol crossover lowers the voltage of the cathode by directly oxidizing methanol instead of allowing an electrochemical reduction between the hydrogen ion and the oxygen at the cathode. As a result, the performance of the DMFC may be significantly lowered.

One of the various efforts to overcome methanol crossover of the polymer electrolyte membrane is to disperse an inorganic filler in a polymer electrolyte matrix to form a composite electrolyte membrane (see U.S. Pat. Nos. 5,919,583 and 5,849,428). Although this type of a composite electrolyte membrane shows somewhat lowered methanol permeability, it also has lowered hydrogen ion conductivity because it contains an inorganic filler that has low cation exchange capability. In other words, as the concentration of the inorganic filler in the composite electrolyte membrane increases, the methanol permeability of the electrolyte membrane and the hydrogen ion conductivity of the electrolyte membrane decrease. The ratio of hydrogen ion conductivity to methanol permeability may be defined as the electrolyte membrane performance index. Thus, there are some limitations to significantly improving the performance index of such a composite electrolyte membrane beyond that of a Nafion® membrane.

There have been attempts to lower the methanol permeability by mixing a polybenzimidazole or polyvinylidene fluoride, a new hydrogen ion conductive organic polymer material, with Nafion® by French researchers in 1997 and by Finnish researchers in 1998 (G. Xavier et al., “Synthesis and characterization of sulfonated polybenzimidazole: A highly conducting proton exchange polymer,” Solid State Ionics 97(1997) 323-331; T. Lehtinen et al., “Electrochemical characterization of PVDF-based proton conduction membranes for fuel cells,” Electrochemica Acta, 43(1998) 1881-1890). These methods are unfavorable because the hydrogen ion conductivity of the polybenzimidazole is only 0.006 S/cm, and the effect of lowering of the electrolyte performance is too high when compared to the lowering of the methanol permeability.

There was an attempt to lower the methanol permeability by hybridizing phosphotungstic acid, a hydrogen ion conductive inorganic material, with Nafion® by Italian researchers (N. Giordano et al., “Analysis of the chemical cross-over in a phosphotungstic acid electrolyte based fuel cell,” Electrochemica Acta, 42(1997) 1645-1652). The result is an organic/inorganic composite membrane that has a disordered state because the composite is prepared by a simple blending. The inorganic material that is used has a hydrogen ion conductivity of only 0.03 S/cm which lowers the overall performance of the electrolyte membrane.

In 2001, Italian researchers made an organic/inorganic composite membrane by mixing a silica with Nafion® (B. Tazi et al., “Parameters of PEM fuel-cells based on new membranes fabricated from Nafion®, silicotungstic acid and thiophene,” Electrochemica Acta, 45(2000) 4329-4339). Silica itself has no hydrogen ion conductivity and is used only to lower the methanol permeability and improve the mechanical strength of the electrolyte membrane.

Zirconium polyphosphate is an inorganic material that is obtained by polymerizing zirconium phosphate, and it was predicted to have a maximum hydrogen ion conductivity of 10 S/cm. There have been some attempts to produce an organic/inorganic composite membrane by mixing zirconium phosphate and the Nafion® by many researchers throughout the world (see U.S. Pat. No. 6,630,265). The membrane is prepared by mixing Nafion® that is dissolved in a solvent with a suspension solution of the zirconium phosphate, agitating and solidifying the mixture in a mold to produce a membrane. In this case, it is very difficult to uniformly disperse the mixed zirconium phosphate particles. It is also known that the randomly dispersed zirconium phosphate disturbs smooth migration of hydrogen ions.

### SUMMARY OF THE INVENTION

The present invention provides a new composite electrolyte membrane that has excellent hydrogen ion conductivity and outstanding methanol exclusion performance.

The present invention also provides a manufacturing method for such a composite electrolyte membrane.

The present invention also provides a fuel cell that comprises such a composite electrolyte membrane.

Additional features of the invention will be set forth in the description which follows, and in part will be apparent from the description, or may be learned by practice of the invention.

The present invention discloses a composite electrolyte membrane that comprises a polymer membrane that conducts hydrogen ions and an exfoliate layer that comprises layers of inorganic materials that conduct hydrogen ions and is disposed on a surface of the polymer membrane.

The present invention also discloses a method for manufacturing a composite electrolyte membrane comprising preparing a suspension solution comprising exfoliates of a layered inorganic material that conducts hydrogen ions. The method further comprises coating the suspension solution of the exfoliates onto a surface of the hydrogen ion conductive polymer membrane and then removing the suspension solvent to form an exfoliate layer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a schematic diagram of a basic structure of a DMFC.

FIG. 2 is a schematic diagram of a composite electrolyte membrane according to an exemplary embodiment of the present invention.

FIG. 3 is a schematic diagram of a composite electrolyte membrane according to exemplary embodiment of the present invention.

FIG. 4 is a XRD graph of an α-zirconium phosphate obtained from one example of the present invention.

FIG. 5 is an electron microscope photo of an α-zirconium phosphate obtained from one example of the present invention.

FIG. 6 is an electron microscope photo of zirconium phosphate exfoliates.

FIG. 7 is an electron microscope photo of an exfoliate layer obtained by first coating according to one example of the present invention.

FIG. 8 is a graph illustrating thickness variation of an exfoliate layer vs. coating number according to one example of the present invention.

FIG. 9 is an experimental result of hydrogen ion conductivity of the composite electrolyte membrane manufactured according to one example of the present invention.

FIG. 10 is a graph illustrating the performance of a fuel cell manufactured according to one example of the present invention.

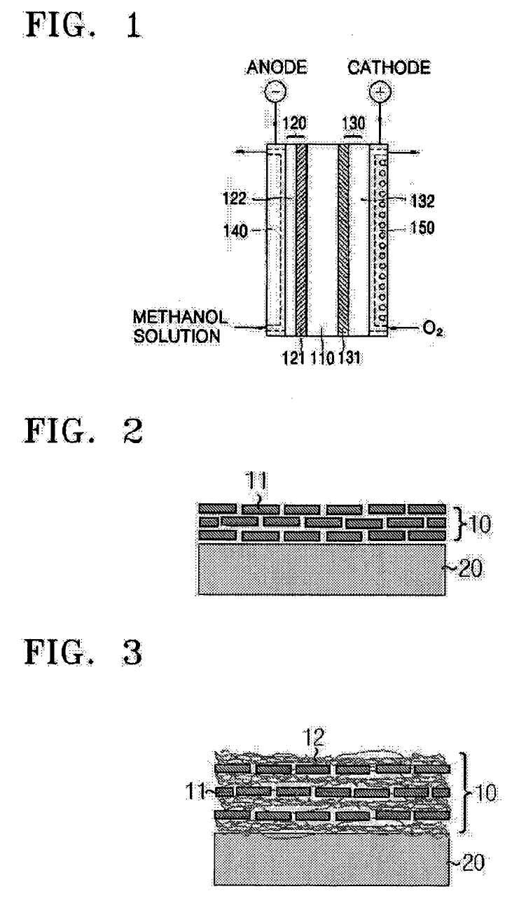

### DETAILED DESCRIPTION OF THE ILLUSTRATED EMBODIMENTS

A composite electrolyte membrane of the present invention includes a hydrogen ion conductive polymer membrane and an exfoliate layer that comprises a hydrogen ion conductive layered inorganic material. The exfoliate layer may disposed on a surface of the polymer membrane.

The composite electrolyte membrane of the present invention allows suppression of methanol permeation, maintenance of hydrogen ion conductivity, suppression of the cathode polarization, and suppression of flooding by water. Thus, the output density and the energy density of a DMFC comprising the membrane may increase and it is possible to make the DMFC system smaller and cheaper. By using an exfoliate layer, it is possible not only to utilize the hydrogen ion conductivity of the inorganic membrane but also to delay the permeation rate of the methanol by extending the pathway of the methanol.

Both the exfoliate layer and the polymer membrane conduct hydrogen ions so that the composite electrolyte membrane also conducts hydrogen ions.

The exfoliate layer acts as an isolation membrane to prevent the diffusion of a liquid phase fuel such as a methanol solution. That is, the diffusion rate of the liquid phase fuel in the exfoliate layer is significantly lower.

There are two diffusion pathways for the liquid phase fuel in the exfoliate layer. One pathway directly transmits the liquid phase fuel through the exfoliate membrane at a very low diffusion rate. The other pathway detours the liquid phase fuel through gaps that are formed between exfoliates. Such a pathway is believed to be very long with respect to the thickness of the exfoliate layer. Thus, the diffusion rate of liquid phase fuel through such a pathway is quite low. As a result, the diffusion of the liquid phase fuel through these two types of pathways in the exfoliate layer will be delayed.

The exfoliates of the layered inorganic materials in the exfoliate layer may be oriented parallel to the surface of the polymer membrane according to an exemplary embodiment of the present invention. In this case, the exfoliate layer can be laminated densely on a surface of the polymer membrane, which makes it possible to minimize the thickness of the exfoliate layer and to maximize the exclusion effects of the liquid phase fuel.

FIG. 2 is a schematic diagram of a composite electrolyte membrane according to a preferred embodiment of the present invention. The composite electrolyte membrane in FIG. 2 includes an exfoliate layer 10 and a polymer membrane 20. Exfoliates 11 are laminated in the exfoliate layer 10. Exfoliates 11 are oriented in a direction parallel to the surface of the polymer membrane 20.

If the exfoliate layer is too thin, it becomes difficult to prevent methanol crossover. In contrast, if the exfoliate layer is too thick, it becomes difficult to transfer hydrogen ions. For these reasons, the exfoliate layer is typically in the range of 1 nm to 100 nm thick, and more preferably, 10 nm to 60 nm thick, and the most preferably is 30 nm to 40 nm.

The exfoliates are obtained by exfoliating hydrogen ion conductive layered inorganic materials. In this case, the term ‘layered inorganic materials’ refers to inorganic materials that are present in the form of particles that comprise two or more laminated sub-layers.

If the particles of the layered inorganic materials are too small, it becomes difficult to prevent a methanol crossover because of the diffusion of the liquid phase fuel. In contrast, if the layered inorganic material particles are too large, it becomes difficult to laminate the exfoliates effectively. For these reasons, the particle size of the layered inorganic materials is typically in the range of 0.2 μm to 20 μm, and more preferably, 0.5 to 3 μm.

If the ion exchange capacity of the layered inorganic materials is too low, it becomes difficult to transfer the hydrogen ions. In contrast, if the ion exchange capacity of the layered inorganic materials is too high, the mechanical strength of the layered inorganic materials is too weak because of the structural defects. On account of these, the ion exchange capacitance of the layered inorganic materials is typically in the range of 2 meq/g to 4 meq/g, and more preferably, 3 meq/g to 3.5 meq/g.

The layered inorganic materials may include, but are not limited to zirconium polyphosphate, alkali transition metal oxide, clay, and graphite oxide.

The exfoliates from such a layered inorganic material are generally in the range of 0.5 nm to 10 nm thick, and more preferably 0.8 nm to 1 nm thick.

In a composite electrolyte membrane of the present invention, a binder may be included in the exfoliate layer to increase the mechanical strength of the exfoliate layer. If the concentration of the binder is too low, it becomes difficult to laminate the exfoliates effectively because the interaction between the exfoliate and the binder is lowered. In contrast, if the concentration of the binder is too high, it becomes difficult to transfer the hydrogen ions. For these reasons, the concentration of the binder in the exfoliate layer is in the range of 0.05 wt % to 0.15 wt %. The binder may be a positively charged polymer that does not lower hydrogen ion conductivity including but not limited to polyallylamine hydrochloride (PAH), polydiallyldimethylammonium chloride (PDADMAC), and polyvinylamine (PVA), polyethyleneimine (PEI).

FIG. 3 is a schematic diagram of a composite electrolyte membrane according to another preferred embodiment of the present invention. The composite electrolyte membrane in FIG. 3 comprises an exfoliate layer 10 and a polymer membrane 20. The exfoliate layer 10 includes exfoliates 11 and a binder 12.

The hydrogen ion conductive polymer membrane used in the composite electrolyte membrane of the present invention may be a polymer comprising a cation exchange group. The cation exchange group may include, but is not limited to a sulfonic acid group, a carboxyl group, a phosphoric acid group, an imide group, a sulfonimide group, a sulfonamide group and a hydroxyl group.

A polymer that comprises a cation exchange group may include but is not limited to trifluoroethylene, tetrafluoroethylene, styrene-divinyl benzene, α,β,β-trifluorostyrene, styrene, imide, sulfone, phosphazene, etherether ketone, ethylene oxide, polyphenylene sulphide or a homopolymer or a copolymer comprising an aromatic group, and derivatives thereof. These polymers may be used in isolation or in combination.

More preferably, the polymer that has a cation exchange group may comprise highly fluorinated polymers wherein the concentration of fluorine atoms is more than 90% of the total constituents that connected to the carbon atoms in the back bone and side chains.

The polymer that has a cation exchange group may also comprise a highly fluorinated polymer with sulfonate groups. The sulfonate group may be located at its terminal and the number of the fluorine atoms may be more than 90% of the total constituents that are connected to the carbon atoms in the back bone and side chains.

For example, a homopolymer prepared from a MSO₂CFR_{f}CF₂O[CFYCF₂O]ₙCF═CF₂ monomer or a copolymer prepared from the monomer and one or more monomers including but not limited to ethylene, halogenated ethylene, perfluorinated α-olefin, or perfluoro alkyl vinyl ether may be used as the polymer that has a cation exchange group. R_{f} is a radical such as a fluorine or a perfluoroalkyl group that has an integer from 1 to 10 carbon atoms, Y is a radical such as a fluorine or a trifluoromethyl group, n is an integer from 1 to 3, M is a radical such as fluorine, a hydroxyl group, an amino group, or an —OMe group. In this case, Me is a radical such as an alkali metal or a quaternary ammonium group.

Also, a polymer that has a carbon backbone that is substantially substituted with fluorine and has a pendant group that is represented by —O-[CFR′_{f}]_{b}[CFR_{f}]ₐSO₃Y may be used as the polymer that has a cation exchange group. In this case, a is 0 to 3, b is 0 to 3, a+b is at least 1, R_{f} and R′_{f} are selected from alkyl groups that are substantially substituted for halogen or fluorine respectively, and Y is hydrogen or an alkali metal.

A sulfonic fluoropolymer that has a backbone that is substituted with fluorine and a pendant group represented by ZSO₂—[CF₂]ₐ—[CFR_{f}]_{b}—O— may be used as the polymer that has a cation exchange group. In this case, Z is a halogen, an alkali metal, a hydrogen or an —OR group, R is an alkyl group or an aryl group that has from 1 to 10 carbon atoms, a is 0 to 2, b is 0 to 2, a+b is not zero, R_{f} is a radical selected from F, Cl, perfluoroalkyl group that has from 1 to 10 carbon atoms or a fluorochloroalkyl group that has from 1 to 10 carbon atoms.

Another example of the polymer material is a polymer represented by the following chemical structure:

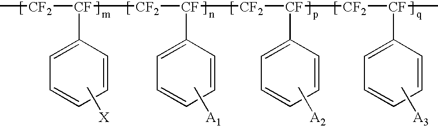

Referring to the structure, m is an integer greater than zero, at least one of n, p, q is an integer greater than zero, A₁, A₂ or A₃ are independently radicals such as an alkyl group, a halogen atom, C_{y}F_{2y+1}(y is an integer greater than zero), an OR group (R is selected from an alkyl group, a perfluoroalkyl group or an aryl group), CF═CF₂, CN, NO₂, and an OH group, for example. X may include, but is not limited to SO₃H, PO₃H₂, CH₂PO₃H₂, COOH, OSO₃H, OPO₃H₂, OArSO₃H (Ar is an aromatic group), NR₃⁺(R may be an alkyl group, a perfluoroalkyl group or an aryl group), and CH₂NR₃⁺(R may be an alkyl group, a perfluoroalkyl group or an aryl group).

If the polymer membrane is too thin, the mechanical strength of the composite electrolyte membrane may be too weak. In contrast, if the polymer membrane is too thick, the internal resistance of the fuel cell may extensively increase. For these reasons, the thickness of the polymer may be in the range of 30 μm to 200 μm.

A low molecular weight emulsifier may be incorporated into the layered inorganic materials so that the polymer resin may penetrate it easily. The layered inorganic materials that are treated in this way are called ‘organified inorganic layered materials.’ Then, the sublayers are exfoliated using a solution method, a polymerization method, a compounding method, etc. The solution method comprising scattering the sublayers by immersing the organified inorganic layered materials into a polymer solution to incorporate the solvent into the sublayers of the organified inorganic layered materials and scattering the sublayers into the polymer resin in the course of drying them. The polymerization method comprises incorporating a monomer into the sublayers of the organified inorganic layered materials and scattering the sublayers by inter-layer polymerization.

Hereinafter, a method for fabricating a composite electrolyte membrane will be described in more detail.

A method for manufacturing a composite electrolyte membrane comprises preparing an exfoliate suspension comprising exfoliates of the hydrogen ion conductive layered inorganic materials and a dispersion medium. The exfoliate suspension is then coated onto a surface of a hydrogen ion conductive polymer layer and the dispersion medium is removed to form an exfoliate layer.

The exfoliate suspension may be obtained by dispersing hydrogen ion conductive layered inorganic materials into a dispersion medium and then cold treating it to exfoliate the sublayers of the hydrogen ion conductive layered inorganic materials. Cold treating refers to stirring the suspension for 3 to 4 hours at 0° C. For example, a material that has weak interaction with molecules that are interposed between the sublayers such as tetra butyl ammonium hydroxide or tetra ethyl ammonium hydroxide may be used as a dispersion medium.

If the concentration of the dispersion medium in the exfoliate suspension is too low, the dispersion may not be complete. If the concentration of the dispersion medium in the exfoliate suspension is too high, the size of the exfoliates will be significantly decreased. For these reasons, the concentration of the dispersion medium in the exfoliate suspension is typically in the range of 30 wt % to 100 wt % and more preferably, 50 wt % to 80 wt % based on the weight of the hydrogen ion conductive layered inorganic materials.

The exfoliate suspension may be coated onto a surface of hydrogen ion conductive polymer layer by spin coating, dip coating, and steady coating for example. Spin coating is preferably used to obtain an exfoliate layer where the exfoliates are oriented parallel to a surface of the polymer membrane.

The removal of the dispersion medium from the exfoliate suspension that is coated onto the hydrogen ion conductive polymer membrane may be performed by any heat treatment method at suitable temperatures based on the used solvent's volatility and boiling point.

The coating of the exfoliate suspension onto a surface of the hydrogen ion conductive polymer membrane followed by removing the dispersion medium may be performed repeatedly to obtain a desired thickness of the exfoliate layer.

Another exemplary embodiment of a method for manufacturing a composite electrolyte membrane according to the present invention comprises preparing an exfoliate suspension comprising exfoliates of the hydrogen ion conductive layered inorganic materials and a dispersion medium. The exfoliate suspension is coated onto a surface of a hydrogen ion conductive polymer layer and the dispersion medium is removed. Then a binder is coated to form an exfoliate layer. These steps may be repeated to obtain a desired thickness of the exfoliate layer.

Solutions of PAH, PDADMAC, PVA, PEI or mixtures thereof, etc. may be used as a binder. Water, alcohol, dimethyl sulphoxide (DMSO), dimethyl formamide (DMF) or mixtures thereof, for example may be used as a solvent for dissolving the binder.

Before being used in the process of forming a membrane-electrode assembly (MEA), the composite electrolyte membrane of the present invention may be pretreated to optimize the performance of the composite electrolyte membrane. The pretreating is performed by completely soaking the composite electrolyte membrane and activating the cation exchange site of the composite electrolyte membrane. The pretreating may be performed, for example, by a process that comprises soaking the composite electrolyte membrane in boiling deionized water for about 2 hours, soaking the composite electrolyte membrane in a boiling of a low concentration sulfuric acid for 2 hours, and soaking the composite electrolyte membrane again in boiling deionized water for about 2 hours.

The composite electrolyte membrane of the present invention may be used in all types of fuel cells that use an electrolyte membrane comprising a polymer electrolyte such as a polymer electrolyte membrane fuel cell (PEMFC) or a direct methanol fuel cell (DMFC). The PEMFC may be operated by supplying a gas that comprises hydrogen to an anode, and the DMFC may be operated by supplying a mixed vapor of methanol and water or a methanol solution to an anode. More preferably, the composite electrolyte membrane of the present invention may be used in the DMFC.

Hereinafter, an embodiment of a fuel cell that comprises the composite electrolyte membrane according to the present invention will be described in more detail.

The fuel cell according to the present invention comprises a cathode, an anode, and an electrolyte membrane that are interposed between the cathode and the anode. The electrolyte membrane in the fuel cell according to the present invention is the composite electrolyte membrane according to the present invention, as described above.

The cathode comprises a catalyst layer that promotes the reduction of oxygen. The catalyst layer comprises a catalyst particle and a polymer that has a cation exchange group. For example, a platinum catalyst, a carbon supported platinum catalyst (Pt/C catalyst), etc. may be used as the catalyst.

The anode includes a catalyst layer that promotes the oxidation reaction of a fuel such as hydrogen, methanol, ethanol, etc. The catalyst layer comprises a catalyst particle and a polymer that has a cation exchange group. For example, a platinum catalyst, a platinum-ruthenium catalyst, a carbon supported platinum catalyst, a carbon supported platinum-ruthenium catalyst, etc. may be used as the catalyst. More preferably, a platinum-ruthenium catalyst and a carbon supported platinum-ruthenium catalyst are useful where the anode of the fuel cell is directly supplied with an organic fuel besides hydrogen.

The catalysts that are used in the cathode and the anode may be a catalyst metal particle or a supported catalyst that includes a catalyst metal particle and a support. For a supported catalyst, a solid conductive particle with micropores that support the catalyst, such as a carbon particle may be used as the support. The carbon particle may include, but is not limited to carbon black, ketjenblack, acetylene black, activated carbon powder, carbon nano-fibre powder, or mixtures thereof. The polymer described above may be used as the polymer that has a cation exchange group.

The catalyst layer of the cathode and the catalyst layer of the anode are in contact with the composite electrolyte membrane respectively.

The cathode and the anode may further comprise a gas diffusion layer in addition to the catalyst layer. The gas diffusion layer may include a porous conductive material. The gas diffusion layer acts as a current collector and as a pathway for transferring reactants and products. For example, carbon paper, more preferably, wet-proof carbon paper, and the most preferably, wet-proof carbon paper that is coated with wet-proof carbon black layer, may be used as the gas diffusion layer. The wet-proof carbon paper may further include a sintered hydrophobic polymer such as polytetrafluoroethylene (PTFE). The wet-proof treatment of the gas diffusion layer assures a pathway for polar liquid reactants and gas reactants. A wet-proof carbon black layer may include carbon black and a hydrophobic polymer such as PTFE as a hydrophobic binder and it is attached to a side of the wet-proof carbon paper described above. The hydrophobic polymer in the wet-proof carbon black layer is also sintered.

The cathode and the anode may be prepared by several methods that are described in numerous sources and will not be fully described in this specification.

Hydrogen, methanol, ethanol, etc. may be used as a fuel that is supplied to an anode of the fuel cell according to the present invention. More preferably, a liquid phase fuel comprising a polar organic fuel and water may be supplied to the anode. For example, methanol or ethanol may be used as the polar organic fuel.

Preferably, the liquid phase fuel may be a methanol solution. Since the crossover of the liquid phase fuel is suppressed by the composite electrolyte membrane, the fuel cell of the present invention may use a higher concentration of the methanol solution. In contrast, a direct methanol fuel cell of the prior art may only use a 6 wt % to 16 wt % methanol solution because of the methanol crossover. Using a methanol solution, the fuel cell of the present invention has an increased lifespan and efficiency because of the suppression of the crossover of the polar organic fuel by the composite electrolyte membrane, and the excellent hydrogen ion conductivity of the composite electrolyte membrane.

The present invention will be described in more detail with reference to the following examples. The following examples are for illustrative purposes and are not intended to limit the scope of the invention.

### EXAMPLE

Synthesis of an α-Zirconium Phosphate

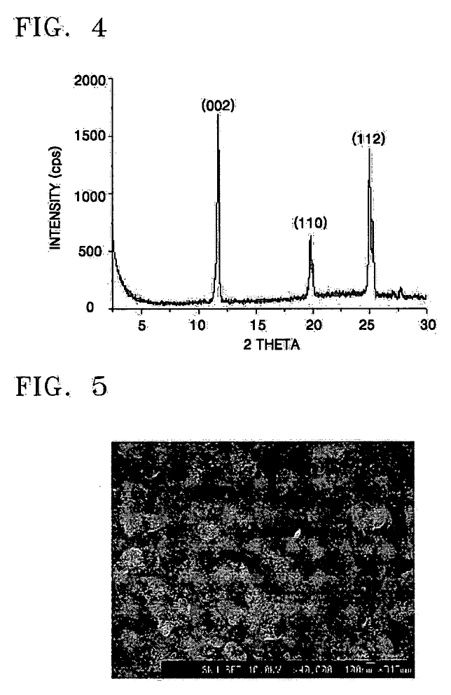

An α-zirconium phosphate with a 200 nm average particle size was prepared by reacting 5 g of zirconyl chloride with 5.49 g of phosphoric acid in a reflux reactor for 24 hours. The XRD graph and the electron microscope photo of the α-zirconium phosphate are respectively shown in FIG. 4 and FIG. 5.

Growing of an α-Zirconium Phosphate Particle

The α-zirconium phosphate thus obtained was continuously treated with ortho-phosphoric acid for three days to increase the average particle size to 2 μm.

Exfoliation of α-Zirconium Phosphate Particle

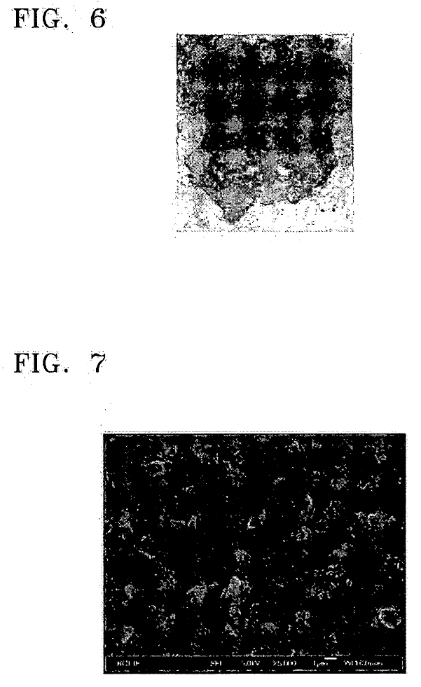

0.1 g of the α-zirconium phosphate thus obtained was exfoliated by cold treatment (0° C., 3 to 4 hours) in 0.64 g of TBA to obtain an exfoliate suspension. The electron microscope photo of the obtained zirconium phosphate exfoliates is shown in FIG. 6.

Formation of an Exfoliate Layer

The exfoliate suspension and PAH were spin coated 1 to 10 consecutive times on a surface of the Nafion 115 membrane. In each stage, the spin coating was performed at 3000 rpm for 20 seconds. The exfoliate layer in the composite electrolyte membrane was maintained in the air and water without separation from the Nafion 115 membrane. The electron microscope photo of a layer of exfoliates obtained after a first coating was shown in FIG. 7. The variation in thickness of an exfoliate layer according to the coating number is shown in FIG. 8. As shown in FIG. 8, when the coating number was ten, the thickness of the exfoliate layer was 48 nm.

Evaluation of Hydrogen Ion Conductivity

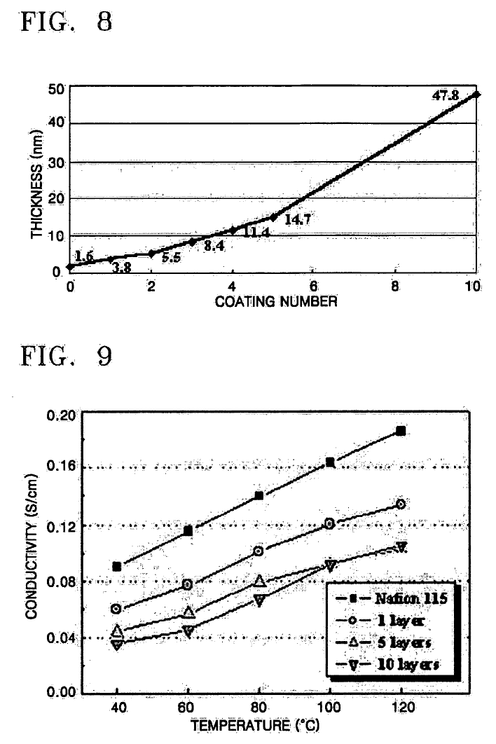

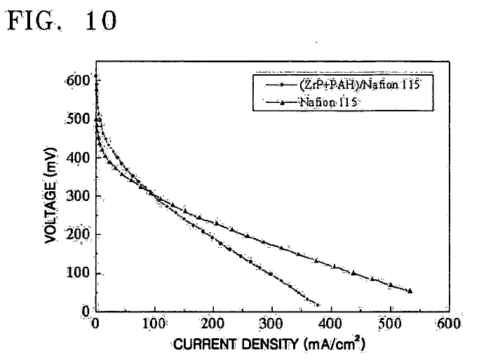

Hydrogen ion conductivity was measured by a 4-point probe method using ‘Voltalab 40’ at 40° C., 60° C., 80° C., 100° C. and 120° C. as shown in FIG. 9. The hydrogen ion conductivity of the Nafion 115 membrane as a comparative example is also shown in FIG. 9.

As shown in FIG. 9, the hydrogen ion conductivity of the composite electrolyte membrane of the present invention gradually decreased as the coating number increased. The hydrogen ion conductivity of the composite electrolyte membrane of the example was lower than that of the Nafion 115 membrane. However, the hydrogen ion conductivity of the composite electrolyte membrane was sufficient to be used as an electrolyte membrane for a fuel cell.

Measurement of Methanol Permeability

The methanol exclusion performance of the composite electrolyte membrane of the example was evaluated by measuring methanol permeability using a diffusion cell. The permeability test was performed by supplying a 2M methanol solution to one side of an electrolyte membrane and measuring the amount of methanol and water that diffused to the opposite side of the electrolyte membrane by gas chromatography.

The results of the methanol permeability tests of the composite electrolyte membrane are summarized in Table 1.

TABLE 1

| | Methanol permeability × 10⁻⁶ |
|---|---|
| | mol/cm² .sec |
| COMPARATIVE EXAMPLE - Nafion | 2.9 (100%) |
| 115 | |
| EXAMPLE - once coated | 2.5 (88%) |
| EXAMPLE - 5 times coated | 2.1 (73%) |
| EXAMPLE - 10 times coated | 1.6 (53%) |

As shown in Table 1, the methanol permeability of the composite electrolyte membrane of the examples gradually decreased as the coating number increased. The methanol permeability of the composite electrolyte membrane according to the examples was lower than that of the Nafion 115 membrane. When coating the composite electrolyte membrane ten times, the methanol permeability was only 53% of that of the Nafion 115 membrane. Based on these results, the exfoliate layer of the composite electrolyte membrane of to the present invention has excellent methanol diffusion exclusion capabilities.

Evaluation of a Fuel Cell

A fuel cell comprising a composite electrolyte membrane (10 times coated) according to the present invention was prepared. A platinum-ruthenium alloy catalyst was used in the anode of the fuel cell and a platinum catalyst was used in the cathode of the fuel cell. The anode, the cathode, and the composite electrolyte membrane of the example were superimposed on one another and then hot-pressed at 120° C. at a pressure of about 5 MPa to from an MEA.

A separation plate for supplying fuel and another separation plate for supplying oxidant were attached to the anode and the cathode of the MEA. Then, the performance of the unit cells were measured under the following operating conditions:
Fuel: 8 wt % methanol solution
Oxidants: air at 50 mL/min
Operation temp.: 50° C.

The performance of a fuel cell that was fabricated according to the example is shown in FIG. 10. The performance of the fuel cell that was fabricated using the same method except that a Nafion 115 membrane was used as an electrolyte membrane is shown as a comparative example.

As shown in FIG. 10, the fuel cell that uses the composite electrolyte membrane (5 times coated) according to the present invention has a greater output density when compared to the fuel cell of the comparative example that uses the Nafion 115 membrane in the low current region where membrane effect is apparent. This is probably because the composite electrolyte membrane of the present invention has sufficient ion conductivity and excellent methanol exclusion capabilities. Also, the OCV diminution by the methanol crossover phenomenon was quite low.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A composite electrolyte membrane, comprising:
a hydrogen ion conductive polymer membrane; and
an exfoliate layer comprising layered hydrogen ion conductive inorganic materials that are disposed on a surface of the polymer membrane.

2. The composite electrolyte membrane of claim 1,
wherein exfoliates of the layered inorganic materials in the exfoliate layer are oriented parallel to a surface of the polymer membrane.

3. The composite electrolyte membrane of claim 1,
wherein the layered inorganic materials comprise zirconium phosphate.

4. A method for manufacturing a composite electrolyte membrane, comprising:
preparing a suspension solution comprising exfoliates of a layered hydrogen ion conductive inorganic material and a suspension medium; and
coating the suspension solution onto a surface of a hydrogen ion conductive polymer membrane; and
then removing the suspension medium to form an exfoliate layer.

5. The method of claim 4,
wherein the exfoliate suspension is spin coated onto a surface of the polymer membrane.

6. A method of manufacturing a composite electrolyte membrane, comprising:
preparing a suspension solution comprising exfoliates of a layered hydrogen ion conductive inorganic material and a suspension medium; and
coating the suspension solution onto a surface of a hydrogen ion conductive polymer layer;
removing the dispersion medium; and
coating a binder; and
optionally repeating the coating and removing steps to form an exfoliate layer.

7. The method of claim 6,
wherein the suspension solution is spin coated onto a surface of the hydrogen ion conductive polymer membrane.

8. A fuel cell, comprising:
a cathode;
an anode; and
the hydrogen ion conductive composite electrolyte membrane of claim 1 that is interposed between the cathode and the anode.
